(19) United States
(12) Patent Application Publication
(10) Pub. No.: US 2026/0093331 A1
(43) Pub. Date: Apr. 2, 2026

(54) SYSTEMS AND METHODS FOR USING AUGMENTED REALITY DEVICE AS A COPY-PASTE UTILITY

(71) Applicant: Adeia Guides Inc., San Jose, CA (US)

(72) Inventors: Dhananjay Lal, Englewood, CO (US); Reda Harb, Saint Petersburg, FL (US); Charles Dasher, Lawrenceville, GA (US)

(21) Appl. No.: 18/900,113

(22) Filed: Sep. 27, 2024

(51) Int. Cl. G06F 3/01; G06V 10/70; G06V 20/20; G06V 40/10; G06V 40/20; H04M 1/72403; H04M 1/72448

(52) U.S. Cl. CPC G06F 3/017; G06F 3/011; G06V 10/70; G06V 20/20; G06V 40/10; G06V 40/28; H04M 1/72403; H04M 1/72448

(57) ABSTRACT

Using an AR device, a content item from a real-world environment is captured. An electronic device within a field of view of the AR device is then identified and a representation of the content item is transferred to the electronic device in response to detecting a user gesture to do so. A context of the electronic device into which the representation of the content item should be transferred is determined and a command is then transmitted to the electronic device to cause transfer of the representation of the content item from the AR device to the electronic device in the determined context.

### BACKGROUND

This disclosure relates to augmented reality (AR) devices. In particular, solutions for copying and pasting real-world objects into other applications using an AR device are provided.

### SUMMARY

AR devices may be used to capture images (whether 2D or 3D, depending on device capability) in the real world. These images may be then processed (e.g., cropped, rotated, stretched, etc.) and used elsewhere. Optionally, the image may contain text that may be extracted from the image for use instead of, or in conjunction with, the image itself. In many examples, these derived images/texts are used in an electronic format on an electronic device other than the capturing AR device. The current invention discusses methods for enabling this transfer of images/texts captured in the real world to another electronic device in a context-aware manner.

In an embodiment, the current invention applies to AR glasses and creates a powerful use case, though it may also apply to other types of AR devices such as a smartphone or tablet. The AR glasses become a device that “copies” relevant information from the real world, and “pastes” it into another electronic device while recognizing the context of the input. Effectively, the AR glasses become a bridge between the real world and the electronic world, i.e., an ecosystem of user digital devices such as their smartphone, tablet, laptop, desktop, TV, etc. AR glasses include devices that may be for AR only such as Xreal Air 2 Ultra, Ray Ban Meta, or XR devices that may be used for AR or VR such as the Meta Quest or Apple Vision Pro. For example, a VR HMD may function as an AR device when in passthrough mode.

Note that while the example describes the use of gestures in conjunction with the AR glasses for facilitating input/output, any device such as a controller, stylus etc. that interoperates with the AR glasses for I/O may be used to achieve the desired result. Furthermore, the systems and methods disclosed herein are not limited by any particular gesture that may be used to achieve the desired transfer of digital information.

There may be other ways to transfer a captured image/text from the AR glasses to another electronic device. In a generic method, the AR glasses have a “Share via” or “Send via” feature that allows the user to send the captured element by selecting an application, followed by selecting a recipient. Addressing how this process manifests for the illustrated example, the user may choose a “Share via . . . Chat App A” followed by selecting the “Recipient X” to send the text string “crazylongdomainname.com”. The net effect, while still the same, is achieved through far greater user effort. In the systems and methods described in this disclosure, the user already has their chat with Recipient X open using their Chat App A, and a simple gesture achieves the desired action when context is understood—the AR glasses are aware of the target device and the application invoked by the user.

In some embodiments, voice commands may be used in conjunction with, or in place of, gestures. Voice commands enable quick and conventional operations. In some embodiments, a contextual menu may be displayed to the user upon selection of an image or text. Contextual menus provide an easy-to-navigate interface for tasks including copy and paste and may improve overall efficiency and usability of the system. In some implementations, eye-tracking may be employed by the AR device or another device to determine the user's focus. The user can select something by focusing on it, then use a voice command to copy and a contextual menu to paste the copied item. This combination may allow precise selection via eye tracking, hands-free operation with voice commands, and easy access to additional options through contextual menus.

It is also noted that a user may directly use their AR glasses instead of another device such as a smartphone (shown in the example) to open an application and deploy the captured image/text in that application. Again, the manifestation relevant to the illustrated example would be that the user opens a companion Chat App A directly on the AR glasses and carries on a conversation with Recipient X. While this is also a distinct possibility, it also may be inconvenient due to operating a keyboard in AR. Users may capture image/text in various contexts. However, they may develop preferences for certain devices when it comes to app usage. For example, a user may read/monitor their email on their AR glasses, they may prefer to respond only using their smartphone or laptop. These preferences occur due to varying degrees of difficulty in performing I/O on different devices.

Thus, the subject matter of this disclosure enhances the usability of AR by retaining its best features of image/video capture and processing while minimizing the need for invoking AR glasses in related usability aspects such as sharing/sending or using the image/processed result within a companion app. The current disclosure is not limited to specific gestures or even type of gestures (e.g., hand gestures, eye gestures). A controller or other input device, or a combination of the above may be used to make the gesture. The current disclosure, however, emphasizes methods to determine that an electronic device is within the AR glasses field of view (FoV) such that an authorization token may be sent to the AR glasses. Furthermore, it emphasizes, the determination of context, whether through gesture parameters, metadata, an embedding/computer vision technique, querying or semantic correlation between the image/text/video/other file to be transferred and a candidate application on the electronic device.

Systems and methods are described herein for utilizing an AR device as a copy-paste utility. As used herein, a content item may be any real-world object or any image, text, video, or other media or multimedia content displayed on or by a real-world object. An AR device may be used to capture a digital representation (e.g., an image, series of images, or video) of a content item. Using the AR device, a representation of a content item from a real-world environment is captured. For example, a user gesture, voice command, or other input may be received that causes the AR device to capture an image of the real-world environment. The input, or a subsequent input, may specify or otherwise indicate a portion of the captured image, or a portion of the real-world environment, containing the desired content item. An electronic device within a field of view of the AR device is then identified and a representation of the content item is transferred to the electronic device in response to detecting a user gesture to do so. A context of the electronic device into which the representation of the content item should be transferred is determined and a command is then transmitted to the electronic device to cause transfer of the representation of the content item from the AR device to the electronic device in the determined context. Transfer may be initiated by the electronic device by, for example, transmitting a request to a server used by the AR device to support AR processing functions. Alternatively, the electronic device may transmit a request directly to the AR device. As another alternative, the command may be a request to the electronic device to confirm that receipt of the representation of the content item is permitted in the determined context. The electronic device may respond with an acknowledgement that triggers transfer of the representation of the content item from the AR device to the electronic device.

In some implementations, a representation of the content item is displayed on a display of the AR device. For example, an area of the AR display may be dedicated to a clipboard application or other application in which copied items are stored for later retrieval by a user. When the content item is captured and/or extracted from the real-world environment, a representation of the content item may be displayed in the dedicated area of the display.

To identify an electronic device to which content items may be transferred, the AR device may first recognize one or more electronic devices within a field of view of the AR device. For example, the AR device may use object recognition, machine learning, or other methods to identify objects within a field of view of one or more cameras or other visual sensors connected to, or integrated with, the AR device. The AR device then transmits a beacon to the identified electronic devices. An electronic device responds to the beacon and the AR device then transmits an indicator to that specific electronic device. The indicator may be a visual or audio indicator that the electronic device, or an application running on the electronic device, is configured to recognize. A response to the indicator is received from the electronic device. Once the response is received, the electronic device is authorized to receive content items from the AR device.

To determine a context of the electronic device into which the representation of the content item should be transferred, the AR device may identify an application displayed on a display of the electronic device. In some implementations, the AR device may transmit a query to the electronic device for an identifier of an application that currently has focus. In response to the query, the electronic device may transmit an identifier of the application, or application type, to the AR device.

In some implementations, a machine learning model may be trained on different applications commonly displayed on electronic devices, such as e-mail clients, chat applications (e.g., SMS applications, WhatsApp, Microsoft Teams, etc.), browsers, content streaming applications (e.g., Netflix, Hulu, etc.), and social media applications (e.g., Facebook, Instagram, etc.). The machine learning module may be tuned to identify an application type based on the layout of the application and the types of objects and/or content displayed within the application. The AR device may capture an image of the display of the electronic device and feed the image into the machine learning model, which then outputs a corresponding application type. Based on the application type, the AR device can determine a context into which the representation of the content item should be transferred. For example, if the application is a chat or e-mail application, the representation of the content item should be transferred into the body of a message. In some implementations, the machine learning model may be configured to distinguish between states of an application type and further define the context accordingly. For example, a chat or e-mail application may be in an inbox view, a message drafting view, or chat conversation view. If the machine learning model determines that the application is in an inbox view, the context into which the representation of the content item should be transferred is a new message. The user would then have to select one or more recipients for the new message. However, if the machine learning model determines that the application is in a message drafting view or an active chat conversation view, the context into which the representation of the content item should be transferred is the user interface element used for message input.

In some cases, multiple applications may be displayed concurrently on the display of the electronic device. For example, the electronic device may be a laptop computer on which two or more application windows are displayed. To determine which application should be the context into which the representation of the content item should be transferred, the AR device determines, based on motion information of a user gesture to initiate the transfer, a path along which the gesture points. A portion of the display of the electronic device that intersects the path is then determined and the application displayed on that portion of the display is identified.

The AR device may further identify an application type of the application displayed on the display of the electronic device and determine, based on the application type, that the application is a telecommunications application, such as a phone application or video conferencing application. In response to determining that the application is a telecommunications application, the AR device identifies at least one contact with whom the telecommunications application is communicating. For example, the AR device may determine a phone number to which a phone call is connected. As another example the AR device may identify a participant in a video conference using facial recognition of the participant's face or optical character recognition of the participant's name or username displayed in the video conferencing application. The electronic device may then transmit a command to cause transfer of the representation of the content item to the electronic device in the context of a message (e.g., chat, SMS, e-mail, etc.) to the at least one contact.

In some implementations, to determine a context of the electronic device into which the representation of the content item should be transferred, the AR device determines a subject matter of the content item. For example, the content item may be a sign for a restaurant. The AR device may then compare the subject matter with a plurality of applications available on the electronic device, and data associated with each application. The AR device then selects an application based on the comparison. For example, an application available on the electronic device may by a chat application, and a recent conversation (e.g., within the last 10 minutes) may have referenced a restaurant. The AR device may determine that the subject matter of the content item (i.e., a restaurant sign) is relevant to that conversation and may select the chat application in response. In another example, the content item may be a URL. The AR device may determine that a browser application is available on the electronic device and that the URL is an internet address that can be accessed via the browser application.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawing are not necessarily made to scale.

FIG. 1 depicts an illustrative example of copying a content item from a real-world environment using an AR device, in accordance with some embodiments of this disclosure;

FIG. 2 depicts an illustrative example of transferring a content item captured from a real-world environment to an electronic device, in accordance with some embodiments of this disclosure;

FIG. 3 depicts a second illustrative example of copying a content item from a real-world environment using an AR device, in accordance with some embodiments of this disclosure;

FIG. 4 is a sequence diagram representing an illustrative process for identifying and authorizing transfer of content items to an electronic device within the field of view of an AR device, in accordance with some embodiments of this disclosure;

FIG. 5 depicts an illustrative example of using a machine learning model to classify applications by type, in accordance with some embodiments of this disclosure;

FIG. 6 depicts an illustrative example of a gesture to transfer content to an electronic device with multiple applications displayed concurrently, in accordance with some embodiments of this disclosure;

FIG. 7 depicts an illustrative example of a gesture to transfer content to an electronic device when no application is displayed, in accordance with some embodiments of this disclosure;

FIG. 8 is a sequence diagram representing an illustrative process for capturing 3D models of content items, in accordance with some embodiments of this disclosure;

FIG. 9 is a block diagram showing components and data flow therebetween of an AR device configured to be used as a copy-paste utility, in accordance with some embodiments of this disclosure;

FIG. 10 is a flowchart representing an illustrative process for utilizing an AR device as a copy-paste utility, in accordance with some embodiments of this disclosure;

FIGS. 11A, 11B, and 11C are a flowchart representing an illustrative process for transferring a content item to a context of an electronic device, in accordance with some embodiments of this disclosure; and

FIG. 12 is a flowchart representing an illustrative process for identifying an application on an electronic device into which to input transferred content, in accordance with some embodiments of the disclosure.

### DETAILED DESCRIPTION

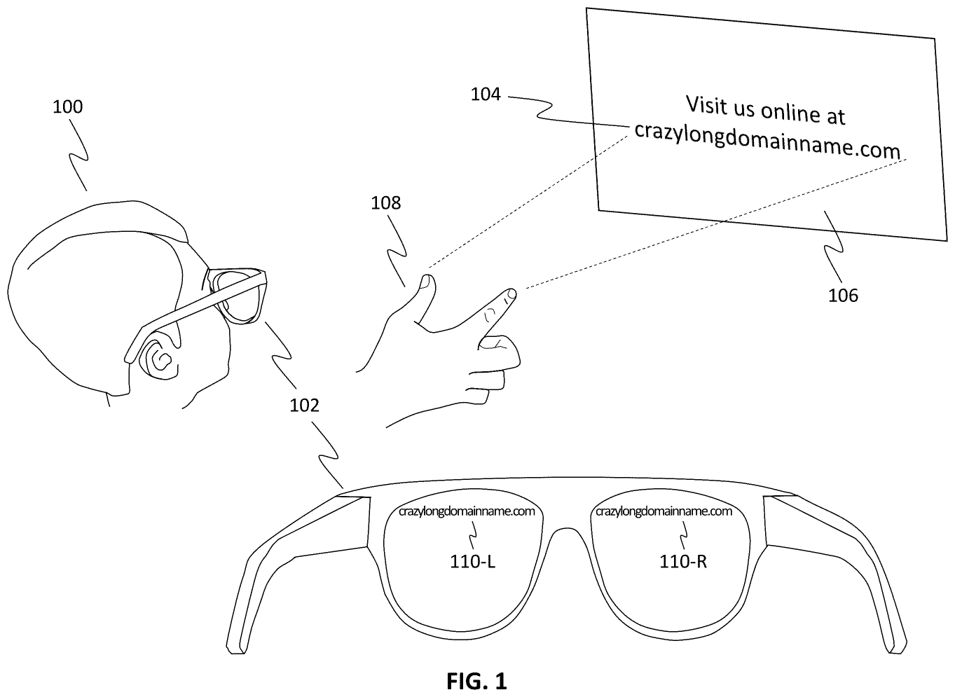

FIG. 1 depicts an illustrative example of copying a content item from a real-world environment using an AR device, in accordance with some embodiments of this disclosure. A user 100 wearing AR device 102 begins by selecting an image element from the real world. For example, the user may want to copy URL 104, “crazylongdomainname.com”, from an advertisement 106 displayed on a TV or computer screen, a sign or billboard, or any other real world element. The user may perform the copying function by using a gesture, such as gesture 108. AR device 102 may be configured to recognize gesture 108 and copy a real-world content item indicated by the gesture. AR device 102 captures an image of the real-world content item in response to gesture 108. For example, using techniques such as depth sensing, machine learning models, and/or computer vision algorithms, the position and movement of the user's hand, including movement and configuration of the user's fingers, can be detected and compared with corresponding position, movement, and configuration data for a series of known or learned gestures. Content contained in the image may be converted into to a text string using optical character recognition or any other suitable technique. In some cases, a series of images and/or a video of the real-world environment may be processed. For example, the content intended by the user for capture may dynamic, such as content displayed on an electronic sign that displays scrolling text or images. Multiple images and/or a video may be used to capture the entirety of the displayed content. Pattern matching algorithms may be used to stitch together the full content from multiple images or frames of video. The image/text of the copies content item persists in AR device 102 for ready recall and reuse, even when the user moves on from the environment where that image/text was captured. An area of a display of AR device 102 may be used for displaying representations of copied content items. For example, the image/text “crazylongdomainname.com” may be displayed in area 110-L and 110-R in order to form a stereoscopic image in the display of AR device 102.

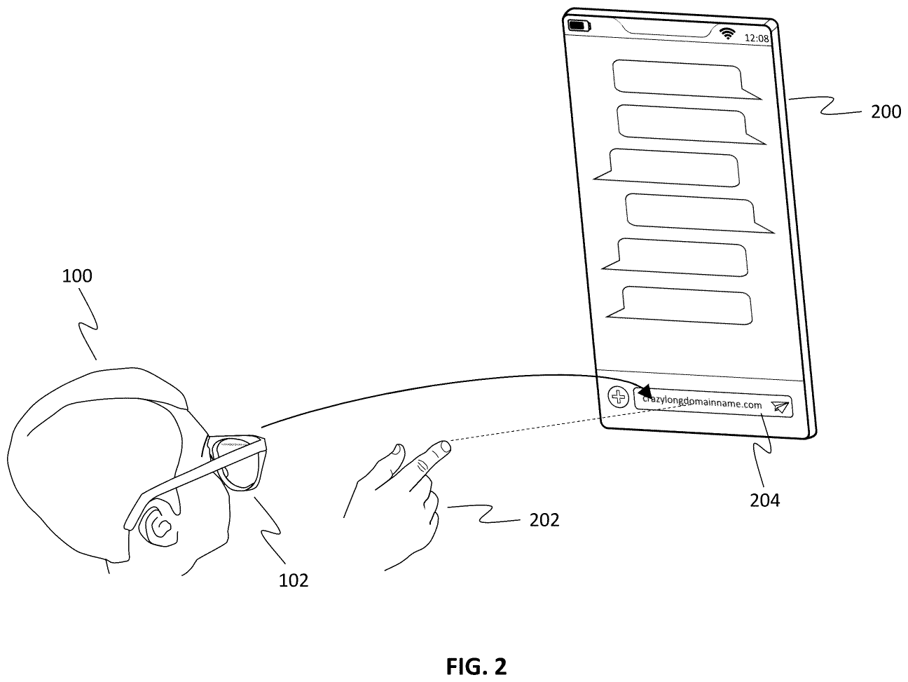

FIG. 2 depicts an illustrative example of transferring a content item captured from a real-world environment to an electronic device, in accordance with some embodiments of this disclosure. User 100 may bring an electronic device 200 into a field of view of AR device 102. User 100 may then use a second gesture 202 to transfer the previously stored image/text to the electronic device. Gesture 202 may be recognized using similar techniques to those described above in connection with gesture 108. In the example of FIG. 2, the user wishes to transfer the captured text “crazylongdomainname.com” to the electronic device in the context of a messaging application or chat application. The resulting effect is that the text string appears as input 204 directly in the application, and the user may then send it to a chat recipient.

To accurately capture a bounded image from a camera of AR device 102, the specific location within the environment as seen by the user and indicated by their gesture must match the corresponding location within an image captured by the camera of AR device 102. Further, to ensure that this occurs, the user must get feedback on the bounding gesture action. In the simplest implementation, the AR device presents the environment to the user as images (i.e., in passthrough mode) rather than in see-through mode. The gesture feedback is also composited on the captured image, thus allowing the user and the AR device to develop a common understanding of a selected area in a larger image. In some embodiments, if the AR device works in both see-through mode and passthrough mode, then the device switches to passthrough mode when the user begins to perform a gesture indicating image bounding and/or capture. In some cases, a user's eye gaze may be used in conjunction with a hand gesture to understand the region of capture/interest.

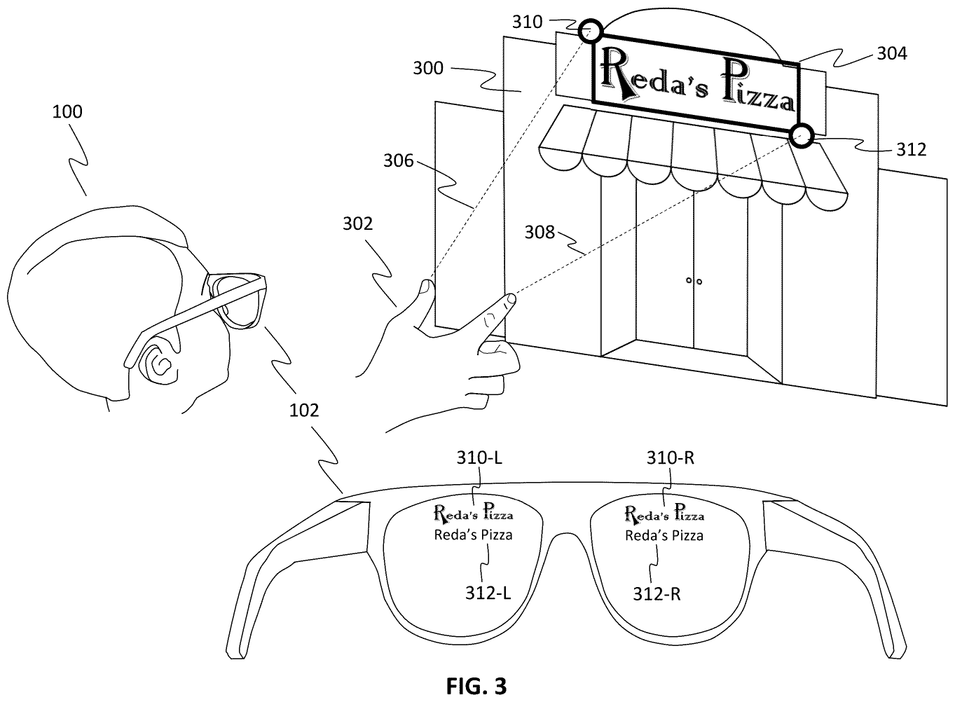

FIG. 3 depicts a second illustrative example of copying a content item from a real-world environment using an AR device, in accordance with some embodiments of this disclosure. The example of FIG. 3 is one in which a user may gesture to bound a portion of a larger image or real-world area for capture and storage. User 100, wearing AR device 102, wants to capture a portion of a real-world area such as the sign on building 300. User 100 uses gesture 302 to bound a rectangular region. AR device 102 determines a point in the real-world area corresponding to a first part of gesture 302 (e.g., based on the direction of the user's thumb) as the upper left-hand corner of the area to be bounded, and a second point in the real-world area corresponding to a second part of gesture 302 (e.g., based on the direction of the user's index finger) as the lower right-hand corner of the area to be bounded. AR device 102 may then capture an image of bounded area 304. In some embodiments, visible 3D rays 306 and 308 may be virtually projected, within the display of AR device 102, from the user's finger or an AR device controller (not shown), that intersects with the environment (intersection determined via a depth camera on AR device 102). This ray is then moved by the user to encircle or bound an object or region of interest. For example, AR device 102 may anchor a first cursor 310 to the position of a first finger of the user's hand while making gesture 302 and anchor a second cursor 312 to the position a second finger of the user's hand while making gesture 302. Bounded area 304 may then be generated using the two cursors as opposing corners of a rectangular area. The captured image/text/video is derived from the bounded region. In some examples, a user may want to save text rather than an image. AR device 102 may use optical character recognition (OCR) to convert any captured text on an image into actual text.

In some cases, well-known user gesture input techniques (such as those currently used in mobile devices) may be used to select a portion from within larger amount of text. Initially, the user captures a bounded image 304, which may be fixed within their FoV as an available image 310-L and 310-R in order to form a stereoscopic image in the display of AR device 102. The user may also activate an image-to-text conversion function to yield the text string “Reda's Pizza” that may also be fixed within their FoV as available text 312-L and 312-R in order to form a stereoscopic image in the display of AR device 102. Subsequently, the user may select a portion of that text (e.g., “Reda's”) by moving one or more text selection markers that delineate a portion of text. Thereafter, the user is able to transfer this text to another electronic device.

After an image/text has been captured and stored, it is available for recall by the user. In some examples, the image/text is displayed on the AR glasses anchored to the AR glasses FoV, albeit not spatially anchored. In another example, the image/text resides on a clipboard which is available on a user home-screen or a button available in current display.

Once the image/text is captured, processed, stored and available for recall, the user may transfer it to another electronic device. The process must begin when the AR glasses recognize an electronic device within their FoV and definitively identify it, i.e., validate the device as the one within their FoV.

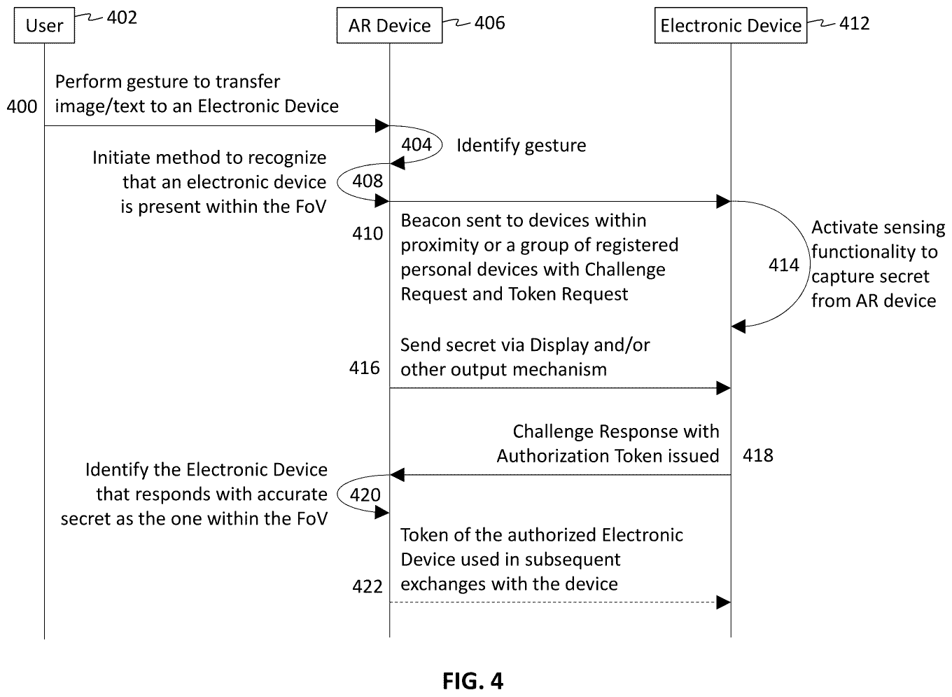

FIG. 4 is a sequence diagram representing an illustrative process for identifying and authorizing transfer of content items to an electronic device within the field of view of an AR device, in accordance with some embodiments of this disclosure. To initiate transfer of content from an AR device to another electronic device, at 400, user 402 gestures to transfer the image/text to an electronic device. At 404, the gesture is identified and recognized by AR device 406. At 408, a process is initiated to recognize at least one electronic device within the FoV of AR device 406. At 410, AR device 406 initiates a communication with candidate devices that may be within the FoV. In some embodiments, a low range communication mechanism or beacon (e.g., RF communication such as Wi-Fi, Bluetooth Low Energy, Zigbee etc.) is used to issue a Challenge Request as well as a Token Request. In other examples, a set of devices associated with the user are known to AR device 406 (or associated a cloud-based backend system that supports the operation of AR device 406) and a Challenge Request is sent via API calls (over any Layer 1/2/3 communication stack) to those authorized devices that may/may not be in proximity. A combination of the above may also be used. A beacon may be sent by AR device 406 that can only be received by devices in proximity, and only known, registered, or authorized devices are allowed to respond. After receiving the Challenge Request, an authorized electronic device 412 may, at 414, activate its sensors to read a secret transmitted, at 416, by AR device 406. For example, the AR device may display a QR code, bar code, number, etc. on its outward-facing display or an LED flashing pattern if a full-feature outward-facing display is not available. Other sensors such as IR, audio microphones, etc., may be activated if a non-visible pattern/secret is transmitted by AR device 406.

Electronic device 412, when within the FoV of AR device 406, may receive this secret and respond, at 418, to the Challenge with the secret and issue a Token to AR device 406. This helps AR device 406 validate, at 420, identify electronic device 412 as an authorized device within its FoV. Further, the Token provides AR device 406 privileges to encapsulate a message with the image/text/video. When received at electronic device 412, the Token helps to validate AR device 406 as the message originator (gesture parameters, other context params, image/text/video) so that the message is presented in a suitable context at the electronic device. In some embodiments, at 422, the Challenge Response may be used as the Authorization Token.

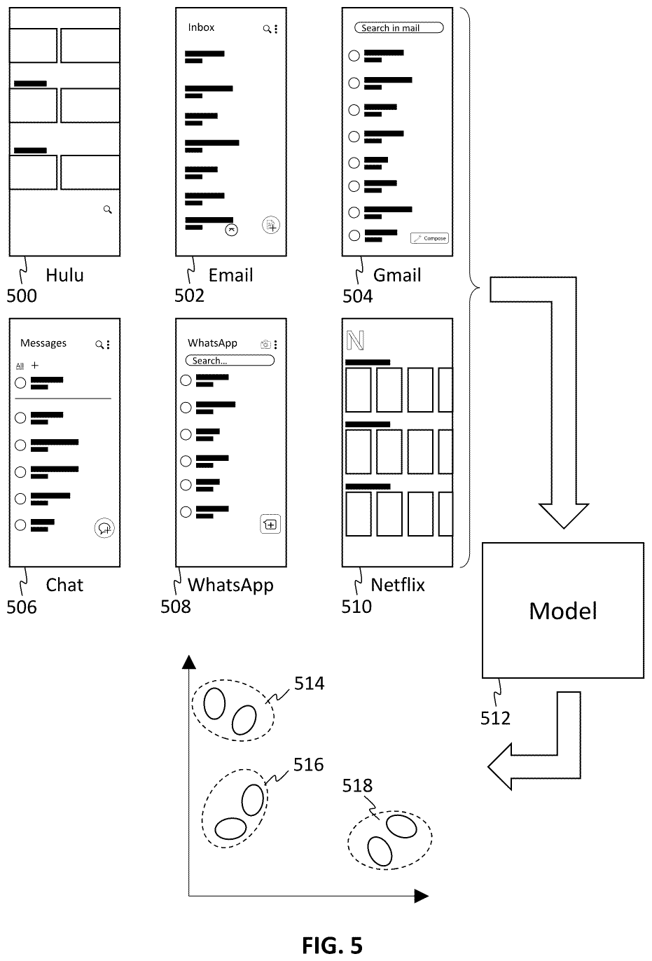

Once an electronic device within FoV has been validated, the next step is to identify the application on the electronic device, covering all or part of the display, that is the target input of the user gesture. FIG. 5 depicts an illustrative example of using a machine learning model to classify applications by type, in accordance with some embodiments of this disclosure. Images of the electronic device display are captured by the AR device. The image of the electronic device display (or a bounded portion of a larger image in which the electronic device display is depicted) is transformed to an embedding space. Embedding is a technique that is used in machine learning, primarily to see the relationship between apparently distinct objects. An example is in language modelling where word2vec is an embedding technique. In language modelling, if the embedding of two different paragraphs or sentences are close, then the paragraph or sentence are semantically closer (similar meaning). It has also been used to train different language models and in translation.

There are many algorithms that can be used for transformation of the electronic device display image with applications into an embedding space. The training data set would be derived from images labeled with the application shown on the electronic device display. In the embedding space, the set of image samples with applications in the same space would be close to each other, while applications in different space will have embeddings that are not close. A training set of samples 500, 502, 504, 506, 508, and 510 could be used to train the parameters of the embedding algorithm to separate out the different spaces. Each sample is a screenshot or other image capture of a different application. For example, sample 500 is a representation of the Hulu application, sample 502 is a representation of a generic email client application, sample 504 is a representation of the Gmail application, sample 506 is a representation of a generic SMS or chat application, sample 508 is a representation of the WhatsApp application, and sample 510 is a representation of the Netflix application. Each of these samples is fed into ML model 512, which then classifies each sample by its application type based on its displayed features. In some embodiments, a Dimensionality Reduction Machine Learning (ML) Model, e.g., Singular Value Decomposition (SVD), Principal Component Analysis (PCA) etc., may be used to make the search for the application on display more efficient. Subsequently, a lower dimension representation of applications in the output of the ML model may be obtained, shown as a reduction to 2D (for simplicity of illustration) in FIG. 5, in which email application may be represented by cluster 514, chat applications may be represented by cluster 516, and content streaming applications may be represented by cluster 518.

In some embodiments, in addition to identifying the potential applications for the input, a short list of possible applications or application categories may be presented next to the selected text/image on the AR device. This way, the user can quickly choose “search”, “album”, “social”, etc., each category corresponding to the most commonly used application of that category on the target electronic device. In addition, for repeated or recurring paste or sharing of text/image, the AR device may establish a default correspondence between an application on the AR device with an application on the target electronic device. For the same type of input, the AR device may establish a correspondence with the last user selected application for a series of data sharing that occurs in a short period of time.

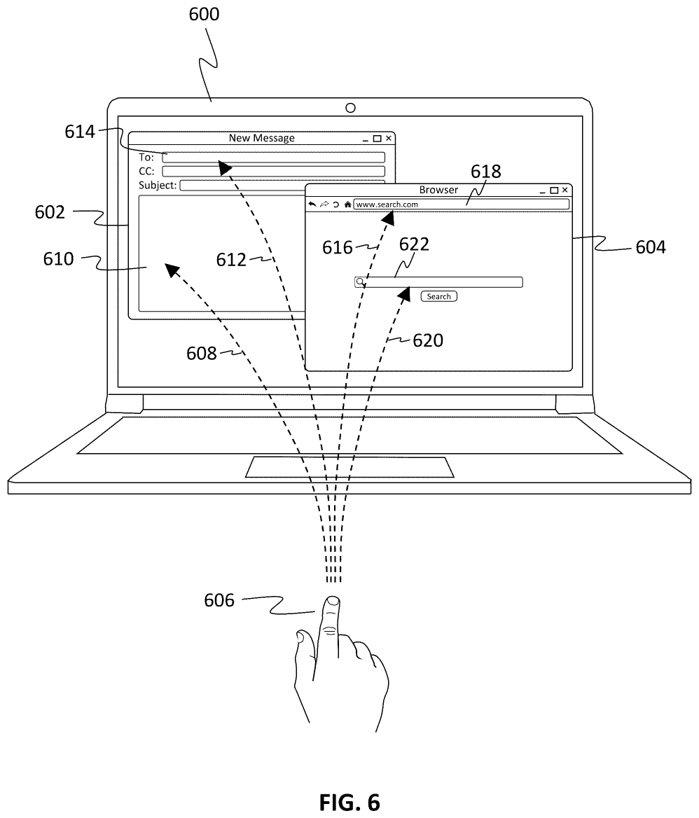

In this manner, both the target electronic device and the target application for input are deduced by the AR device. In some embodiments, the user gesture may not precisely indicate a target application, but rather a location on a display of the target electronic device to indicate one of several applications on the display. In other embodiments, the user gesture may indicate not only an application being displayed, but also a location within the application interface where the image/text is desired to be placed. This is illustrated in FIG. 6, wherein a user is placing a text string derived through bounded capture by their AR device into a laptop 600. A location parameter or other movement information associated with the gesture may indicate an area of the display on which email application 602 is displayed or an area on the display on which browser application 604 is displayed. If, as in the example of FIG. 6, two application windows overlap, a user gesture indicating an area of the display in which the applications overlap is treated by the AR device as indicating the top application window. In this example, a gesture indicating the overlap area is treated as indicating browser application window 604 which covers a portion of email client application window 602.

User gesture 606 may be processed by the AR device to determine motion information associated with user gesture 606. For example, when performing user gesture 606, the user may have moved their hand in a particular direction or extended a finger in a particular direction. The AR device may use this information to determine a portion of the display of the electronic device to which the gesture points. For example, the AR device may determine, based on the motion information of user gesture 606, that user gesture 606 travelled along, or otherwise indicated, motion path 608. Extrapolating motion path 608 to a position on the display of laptop 600, the AR device may determine that user gesture 606 indicates email client application window 602. Since there are multiple input fields present in the user interface of email client application window 602, AR device may further determine that the motion path indicates email body input area 610 and transfer a representation of the content item to laptop 600 with a context corresponding to email body input area 610. If user gesture travelled along, or otherwise indicated, motion path 612, the AR device may also determine that user gesture 606 indicates email client application window 602, but indicates a recipient input field, such as “To” field 614. The AR device may then transfer a representation of the content item to laptop 600 with a context corresponding to “To” field 614.

Similarly, if user gesture 606 travelled along, or otherwise indicated, motion path 616, the AR device may determine that user gesture 606 indicates browser application window 604. Extrapolating motion path 616 to a position on the display of laptop 600, the AR device may determine that user gesture 606 indicates address bar 618 of browser application window 604. The AR device may then transfer a representation of the content item to laptop 600 with a context corresponding to address bar 618. If user gesture 606 travelled along, or otherwise indicated, motion path 620, the AR device may also determine that user gesture 606 indicates browser application window 604, but indicates input field 622 displayed on a webpage currently being accessed within the browser application, such as a search input field of a search engine. The AR device may then transfer a representation of the content item to laptop 600 with a context corresponding to input field 622.

In the final step of the transfer, the AR device uses display input emulation software to deliver the image/text to the target electronic device application. This may require a pre-authorization/setup phase to allow the electronic device to accept input emulation from the AR device. In this phase, the user may give permission on the user's electronic device to allow their AR device to send input to the device as a keyboard, mouse, touchscreen, or other input device. Once this permission is obtained, the AR device may encapsulate the image/text as touchscreen input and send the encapsulated image/text via a communication mechanism (e.g., low range RF protocol, or as a message that passes through a cloud backend). The received message is then decapsulated and presented contextually on the UI of the electronic device. The authorization token, originally issued by the electronic device, validates the AR glasses as the message originator, effectively providing the AR glasses permission to request a deeper level (e.g., OS level) utility in the electronic device such as a keyboard emulation module or video player module in presenting the decapsulated information (image, text, video etc.).

In some embodiments, the AR device may query the electronic device to determine a suitable application for sending the input. In one example, the AR device may request identifiers of any applications currently displayed on the display of the electronic device. After receiving a response, the AR device may send the encapsulated image/text to the device addressed to the specific application. In another example, the AR device may query the electronic device to receive a set of possible target applications. The AR device may present a choice to the user for selection of an application. Alternatively, the AR device may select an application based on user profile behavior and contextual information (e.g., the user sent a message to a friend 15 minutes ago via WhatsApp). To determine the context for choosing a suitable application, the AR device may analyze the text/image to determine a theme, content format (e.g., date/time format), syntax, or other features of the text/image.

In some embodiments, the AR device may send the encapsulated text/image to the electronic device while allowing the electronic device to determine where to place the text/image based on context. For example, the AR device may send an encapsulated text labeled as keyboard I/O to the electronic device. The electronic device, based on all applications that are currently running in the foreground, or on applications currently displayed, or a number of applications recently uses, may select the appropriate application for directing this keyboard input. In some examples, an application may accept input at multiple locations, and the appropriate location is also chosen for entering the input. The AR device may determine a context for a suitable I/O location by analyzing the text/image to determine theme, content format (e.g., date/time format) and syntax etc. In some examples, the user may be asked to select or confirm the application. It should be noted that the software module that selects an application based on context will lie at the operating system level of the electronic device. In some embodiments, the AR device shares metadata about the image/text/video file that assists the electronic device in determining context and placing it in appropriately within an application. A semantic correlation may be developed between the image/text/video/other file and a target application on the electronic device. The semantic correlation may also include user profile data and/or user history data. For example, a user may be discussing lamps with a contact using a chat application. Five minutes later, the user may gesture to capture an image of a lampshade. Based on the context (e.g., metadata), the electronic device may place the captured image in a chat input dialog for that chat conversation.

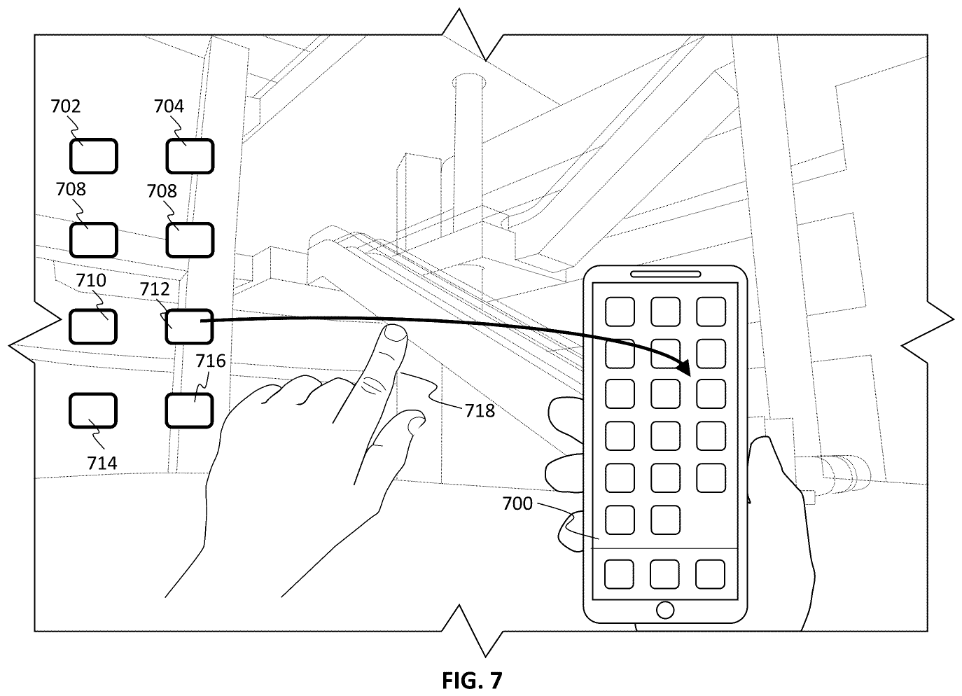

FIG. 7 depicts an illustrative example of a gesture to transfer content to an electronic device when no application is displayed, in accordance with some embodiments of this disclosure. In this example, the electronic device 700 is in its home-screen menu rather than displaying an application. Content icons 702-714 correspond to representations of content items copied by the user and available to paste into applications on electronic device 700. These icons are displayed in the display of the AR device (e.g., while in see-through mode as depicted in the example of FIG. 7). In some embodiments, the AR device adjusts the projection depth of the image/text/video/other file icons to match the depth of the detected/identified electronic device. In some embodiments, the image/text/video/other file icons are projected at a default depth (focal distance) and the user is prompted to adjust their electronic device to match the default depth (e.g., hold at a distance within a threshold of default depth). The user may gesture 718 to add the image to a particular application, if the gesture detection mechanism allows inferring a precise location parameter. Alternatively, the application may be picked based on context that may be derived from the image analysis or user profile/behavior history.

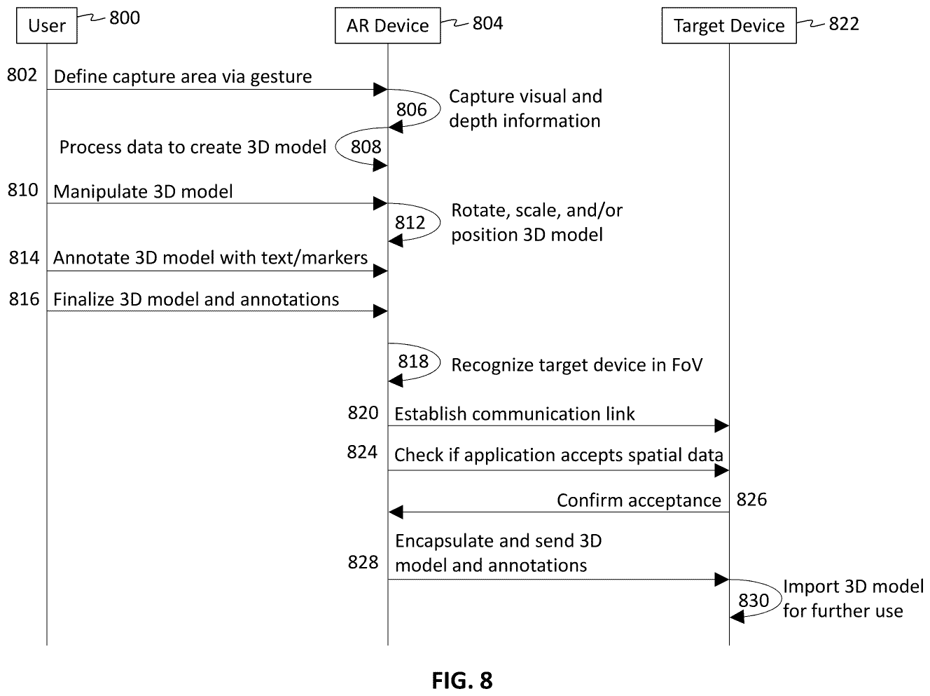

FIG. 8 is a sequence diagram representing an illustrative process for capturing 3D models of content items, in accordance with some embodiments of this disclosure. In an embodiment, the capture (copy) and transfer (paste) of 3D images and their spatial data, incorporating depth information, is possible. This makes the system particularly useful for applications requiring spatial context, such as interior design, architecture, prototyping, and augmented reality content creation. The process begins similarly to the primary embodiment with user 800, at 802, gesturing to define a capture area within the field of view (FoV) of AR device 804. In this case, AR device 804 utilizes stereoscopic cameras or structured light sensors to capture, at 806, both the visual and depth information of the selected region. At 808, the captured data is then processed to create a 3D model of the bounded area, which can include objects, text, and other relevant features. This 3D model is stored within a memory of AR device 804. Once the 3D model is captured, the user can, at 810, manipulate it within the AR environment. Manipulations can include rotating, scaling, and positioning the 3D model to achieve the desired orientation and size. The user may use gestures to achieve these manipulations. AR device 804 may recognize the gestures and, at 812, rotate, scale, and/or position the 3D model accordingly. Additionally, at 814, the user can use gestures or voice commands to annotate the 3D model with text or other markers, enhancing its informational content. At 816, the user finalizes the 3D model and any annotations. After the 3D model and any associated annotations are finalized, the AR device enables the transfer of this data to another electronic device which has indicated that it is able to receive 3D or spatial data. This transfer process involves recognizing, at 818, the target electronic device within the user's FoV and, at 820, establishing a communication link between AR device 804 and target device 822 as described above. At 824, AR device 804 checks if an application available on target device 822 can accept spatial data. Target device 822 may transmit, at 826, a confirmation that at least one available application can accept spatial data. In response, at 828, AR device 804 encapsulates the 3D model and its annotations and sends them to target device 822. For example, if the receiving device is a tablet with a CAD application, the CAD application is identified as the context into which the encapsulated content should be transferred. At 830, the 3D model can be directly imported into the application for further manipulation and use. Similarly, if the receiving device is a smartphone with an AR content creation app, the model can be incorporated into an AR scene.

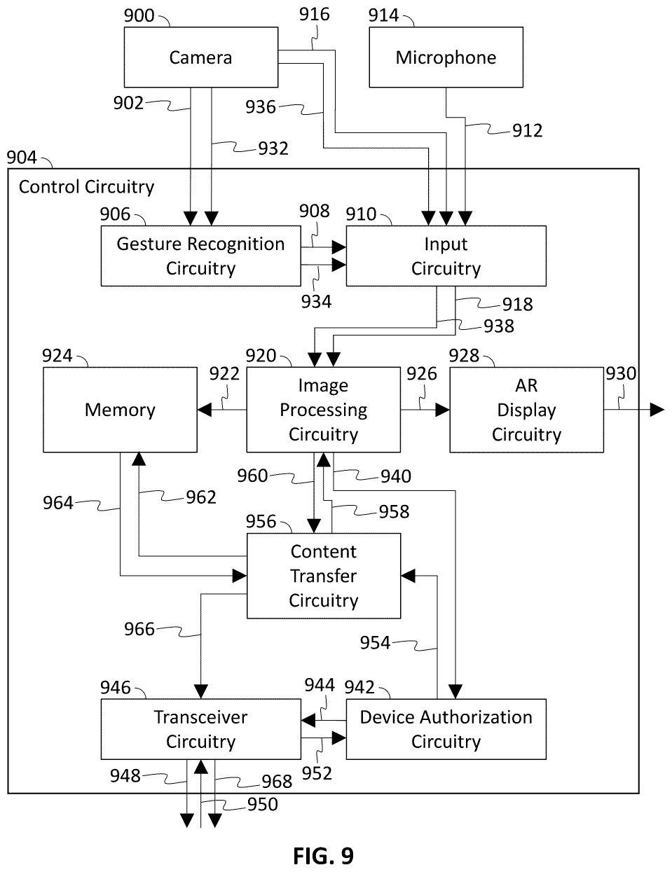

FIG. 9 is a block diagram showing components and data flow therebetween of an AR device configured to be used as a copy-paste utility, in accordance with some embodiments of this disclosure. Camera 900 of the AR device captures images of a real-world environment. Camera 900 has a field of view that encompasses an area in front of the AR device. In some embodiments, camera 900 is fitted with a wide-angle lens, allowing it to capture a wider field of view. Camera 900 transmits 902 captured images to control circuitry 904 where they are received at gesture recognition circuitry 906. Control circuitry 904 may be based on any suitable processing circuitry and comprises control circuitry and memory circuitry, which may be disposed on a single integrated circuit or may be discrete components. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Gesture recognition circuitry 906 processes images received from camera 900 to identify gestures made by the user. For example, the AR device may have a number of built-in gestures to allow users to quickly perform certain actions. The AR device may also allow for users to record custom gestures. Gesture recognition circuitry 906 identifies a user's hand within an image or video and determines the position and placement of one or more portions of the user's hand (e.g., the position and placement of each finger of the hand). Gesture recognition circuitry 906 compares the position and placement of each portion of the user's hand to corresponding data for each known gesture. If a match is found, gesture recognition circuitry 906 transmits 908 a corresponding instruction to input circuitry 910. Input circuitry 910 is configured to accept and interpret various types of inputs from hardware integrated into the AR device (e.g., camera 900), external input devices (e.g., keyboard, touch interface, controller, etc.), voice inputs (e.g., received 912 from microphone 914), etc.

If gesture recognition circuitry 906 recognizes a gesture indicating that the user wants to copy content from the real-world environment, gesture recognition circuitry 906 transmits 908 an instruction to input circuitry 910 to retrieve an image of the real-world environment. Input circuitry 910 then retrieves 916 an image from camera 900 and transmits 918 the image to image processing circuitry 920. Gesture recognition circuitry 906 may also determine, based on the gesture, specific area of the real-world environment from which content should be copied. Gesture recognition circuitry 906 may extract spatial information associated with the determined area and include it in the instruction. Input circuitry 910 may then transmit the spatial information to image processing circuitry 920 along with the image from camera 900.

Image processing circuitry 920 extracts from the image a representation of the content depicted in the area indicated by the spatial information. Image processing circuitry 920 may then transmit 922 the representation of the content item to memory 924. Memory 924 may be any suitable electronic storage device such as random-access memory, read-only memory, hard drives, optical drives, solid state drives, quantum storage devices, or any other suitable fixed or removeable storage devices, and/or any combination of the same. Image processing circuitry 920 may also perform optical character recognition to convert text in the indicated area to a string. Image processing circuitry 920 may also store this string in memory 924. Once the representation and/or text of the indicated area of the real-world environment have been extracted, image processing circuitry 920 transmits 926 the representation and/or text to AR display circuitry 928. AR display circuitry 928 drives an AR display, such as lenses in a pair of AR glasses. AR display circuitry 928 generates and outputs 930 for display the representation and/or text of the content.

A second captured image may be transmitted 932 from camera 900 to gesture recognition circuitry 906. Gesture recognition circuitry 906 may determine, based on the second captured image, that the user made a gesture indicating that a stored representation of a content item should be transferred to an electronic device. Upon making this determination, gesture recognition circuitry 906 transmits 934 an instruction to input circuitry 910 to identify an electronic device to which the content should be transferred. Input circuitry 910 then retrieves 936 an image from camera 900 depicting the entire field of view of the AR device and transmits 938 the image to image processing circuitry 920. Image processing circuitry 920 processes the image using object recognition or any other suitable image processing technique to identify one or more electronic devices depicted in the image. If no devices are found in the image, the AR device may ignore the gesture or notify the user that the action associated with the gesture (i.e., transfer of content to an electronic device) cannot be completed.

If at least one electronic device is determined to be depicted in the image, image processing circuitry 920 transmits 940 an instruction to device authorization circuitry 942 to establish a connection with an electronic device. Device authorization circuitry 942 generates a Challenge Request and a Token Request to authorize an electronic device. Device authentication circuitry 942 may also generate a secret to be transmitted to an electronic device to confirm or validate its authentication. Device authentication circuitry 942 transmits 944 the Challenge Request, the Token Request, and the secret to transceiver circuitry 946. Transceiver circuitry 946 may comprise a network connection over which data ban be transmitted to an received from remote devices, or a low range communication mechanism or beacon (e.g., RF communication such as Wi-Fi, Bluetooth Low Energy, Zigbee etc.). Transceiver circuitry 946 transmits the Challenge Request, the Token Request, and the secret to at least one electronic device. In some embodiments, a set of devices associated with the user are known to the AR device (or associated a cloud-based backend system that supports the operation of the AR device) and the Challenge Request is sent via API calls (over any Layer 1/2/3 communication stack) to those authorized devices that may or may not be in proximity. A combination of the above may also be used. Transceiver circuitry 946 may send a beacon that can only be received by devices in proximity, and only known, registered, or authorized devices are allowed to respond. After receiving the Challenge Request, an authorized electronic device may activate its sensors to read the secret transmitted by the AR device. For example, the AR device may display a QR code, bar code, number, etc. on its outward-facing display or an LED flashing pattern if a full-feature outward-facing display is not available. Other sensors such as IR, audio microphones, etc., may be activated if a non-visible pattern/secret is transmitted by the AR device.

Transceiver circuitry 946 receives 950 a response to the Challenge Request and Token Request from an electronic device. Transceiver circuitry 946 then transmits 952 the response to device authentication circuitry 942 to complete the authorization process. Once the authorization process is complete, device authorization circuitry 942 transmits 954 an instruction to content transfer circuitry 956 to transfer the content to the authorized device. In some implementation, content transfer circuitry determines a context of the electronic device into which the content will be transferred. This may be accomplished by processing an image of the display of the electronic device to identify an application or type of application currently being displayed. Content transfer circuitry 956 requests 958 the image of the electronic device from image processing circuitry 920. In response, image processing circuitry 920 transmits 960 the image to content transfer circuitry. In some implementations, image processing circuitry 920 may further process the image to extract only the portion of the image depicting the authorized electronic device. In other implementations, image processing circuitry 920 may determine an area of the image that depicts the authorized electronic device and transmit to content transfer circuitry, along with the image, an indication of the area of the image (e.g., bounding coordinates). Content transfer circuitry 956 may use a machine learning model to identify the application or type of application displayed. For example, content transfer circuitry 956 may feed the image of the display of the electronic device into a machine learning model that was trained on different application views, as discussed above in connection with FIG. 5, which outputs an identifier of the application or type of application.

Content transfer circuitry 956 transmits a request 962 to memory 924 to retrieve the store representation of the content item to be transferred to the electronic device. In response to the request, memory 924 transmits 964 the stored representation of the content item to content transfer circuitry 956. Content transfer circuitry 956 then encapsulates the representation of the content item, along with any context information, API calls, or other data needed to direct the electronic device to place the content item in a given context, into a content transfer message in a suitable transmission format. Content transfer circuitry 956 then transmits 966 the content transfer message to transceiver circuitry 946, which in turn transmits 968 the content transfer message to the electronic device.

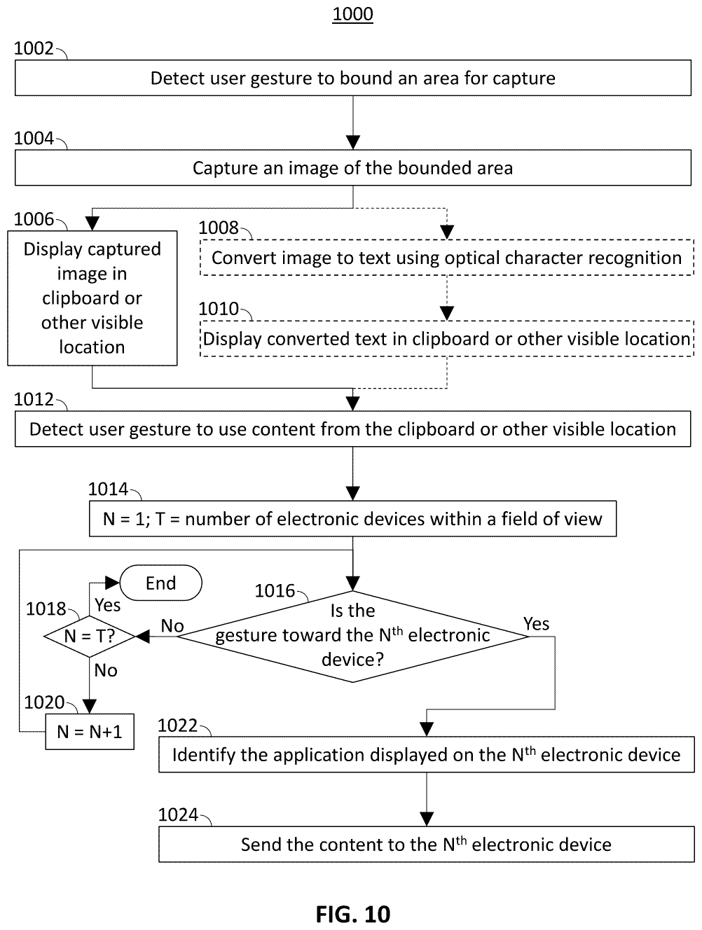

FIG. 10 is a flowchart representing an illustrative process 1000 for utilizing an AR device as a copy-paste utility, in accordance with some embodiments of this disclosure. Process 1000 may be implemented on control circuitry 904. In addition, one or more actions of process 1000 may be incorporated into or combined with one or more actions of any other process or embodiments described herein.

At 1002, control circuitry 904 detects a user gesture to bound an area for capture. For example, control circuitry 904 may recognize a hand gesture of the user. Control circuitry 904 may then determine a vector, ray, or other path from the gesture. Using the vector, ray, or other path, control circuitry 904 identifies an area of the environment, within the field of view of the AR device, indicated by the gesture.

At 1004, control circuitry 904 captures an image of the bounded area. For example, control circuitry 904 may store an image of the entire field of view of the AR device along with metadata identifying the bounded area. Alternatively, control circuitry 904 may crop the captured image to the bounded area and store only the cropped image, discarding the remaining image data.

At 1006, control circuitry 904 displays the captured image in a clipboard or other visible location. A portion of the AR display may be dedicated to a clipboard. Stored content items may be displayed in this portion of the AR display far easy access by the user. If the stored image is of the entire field of view of the AR device, control circuitry 904 may display only the bounded area in the clipboard. In some embodiments, at 1008, control circuitry 904 converts the image to text using OCR techniques and, at 1010, displays the converted text in the clipboard. The text may be displayed in place of, or in addition to, the image.

At 1012, control circuitry 904 detects a user gesture to use content from the clipboard or other visible location. For example, control circuitry 940 may recognize a second hand gesture of the user as indicating a selection of both a content item from the clipboard area and another device within the field of view of the AR device. An example of such a gesture may be a grabbing or pinching gesture in the clipboard display area followed by a movement, throwing, or pointing gesture toward another device, or simply outward from the AR device.

At 1014, control circuitry 904 initializes a counter variable, setting its initial value to one, and a variable T representing the number of electronic devices within the field of view of the AR device. The number of devices may be determined using object recognition on an image depicting the entire field of view of the AR device.

At 1016, control circuitry 904 determines whether the gesture is toward the Nth electronic device. For example, control circuitry 904 may determine a motion vector or other movement information from the gesture and identify an area of the field of view toward which the gesture moved or pointed. Control circuitry 904 may determine if the identified area contains the N^{th} electronic device by, for example, comparing coordinates of the identified area to coordinates of the N^{th} electronic device. If the gesture is not towards the N^{th} electronic device (“No” at 1016), then, at 1018, control circuitry 904 determines whether N is equal to T, meaning that all electronic devices have been checked. If N is equal to T (“Yes” at 1018), then control circuitry 904 determines that no electronic devices are present in the field of view of the AR device, and the process ends. If N is not equal to T (“No” at 1018), then, at 1020, control circuitry 904 increments the value of N by one, and processing returns to 1016.

If the gesture is towards the N^{th} device (“Yes” at 1016), then, at 1022, control circuitry 904 identifies the application displayed on the N^{th} electronic device. For example, control circuitry 904 may process an image of the display of the electronic device to identify the application, or type of application. Control circuitry 904 may use a machine learning model to identify the application, as discussed above.

At 1024, control circuitry 904 sends the content to the N^{th} electronic device. Control circuitry 904 may use the identified application or type of application to set a context for transfer of the content item. Control circuitry 904 may encapsulate the content item and any contextual information, API calls, etc., into a message which is then sent to the N^{th} electronic device.

The actions and descriptions of FIG. 10 may be used in any other embodiment of this disclosure. In addition, the actions and descriptions described in relation to FIG. 10 may be done in suitable alternative orders or in parallel to further the purposes of this disclosure.

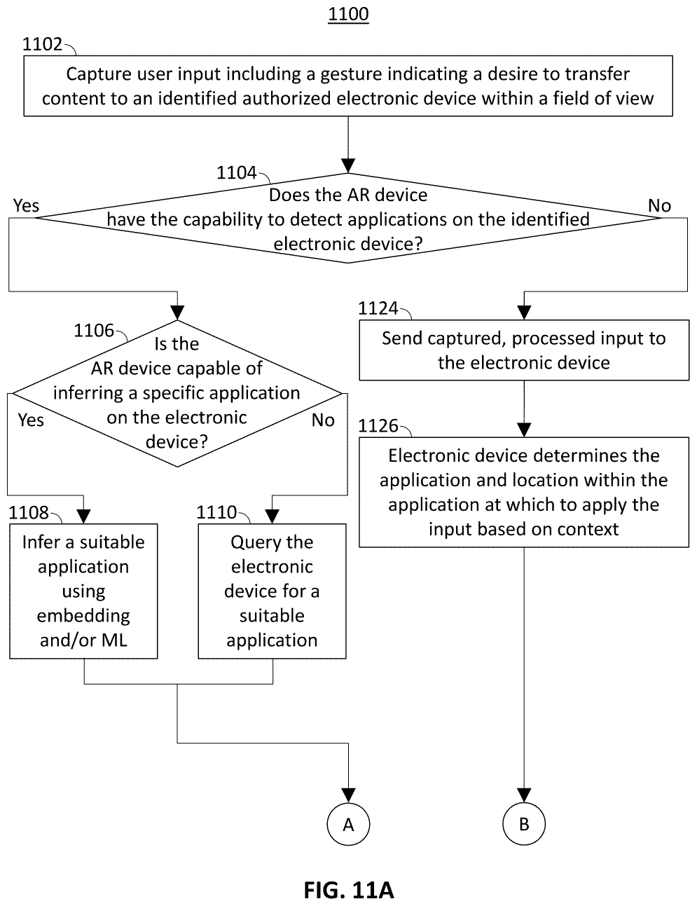

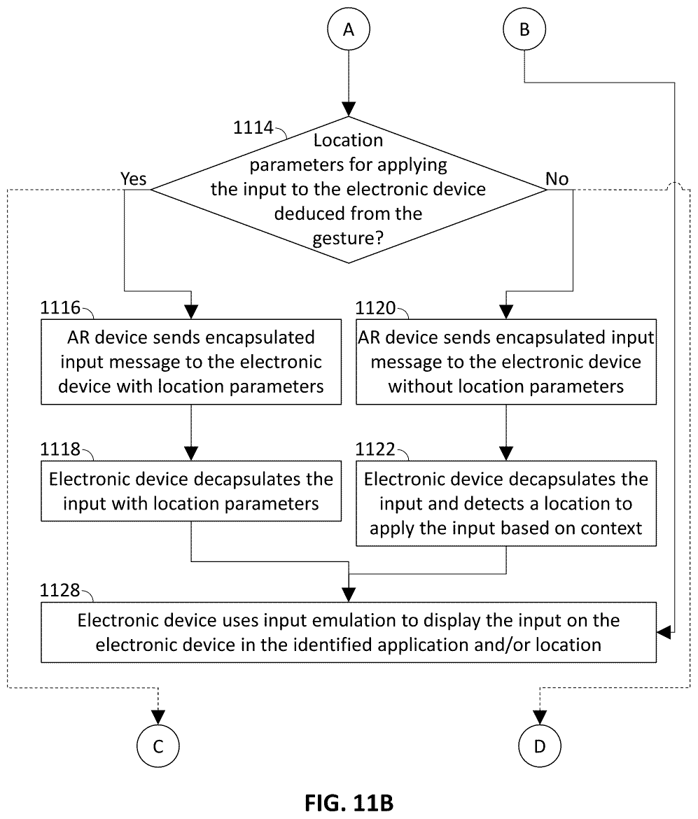

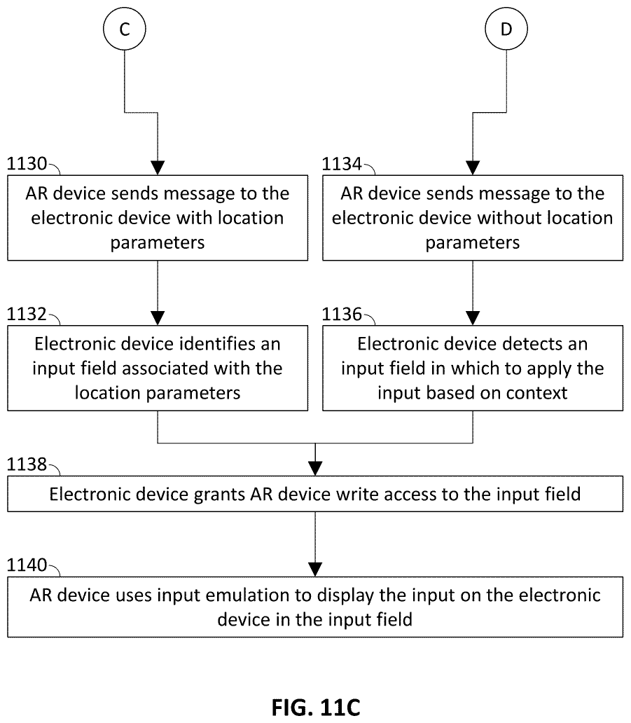

FIGS. 11A, 11B, and 11C are a flowchart representing an illustrative process 1100 for transferring a content item to a context of an electronic device, in accordance with some embodiments of this disclosure. Process 1100 may be implemented on control circuitry 904. In addition, one or more actions of process 1100 may be incorporated into or combined with one or more actions of any other process or embodiments described herein.

At 1102, control circuitry 904 captures user input including a gesture indicating a desire to transfer content to an identified authorized electronic device. For example, the gesture may be series of movements by the user including a grabbing or pinching movement in an area of the AR display in which the content item is displayed, followed by a movement, throwing motion, or pointing motion. Control circuitry 904 uses motion information of the gesture to determine that the movement of the gesture indicates a specific electronic device within the field of view of the AR device.

At 1104, control circuitry 904 determines whether the AR device has the capability to detect application on the identified electronic device. For example, if the display of the electronic device is not visible, the AR device may not be able to detect applications currently running on the electronic device. The AR device may also determine if an API is available for the electronic device and, if so, whether the API allows the AR device to query the electronic device for a list of applications currently installed or running on the electronic device.

If the AR device has the capability to detect applications on the identified electronic device (“Yes” at 1104), then, at 1106, control circuitry 904 determines whether the AR device is capable of inferring a specific application on the electronic device. For example, control circuitry 904 may be able to determine a specific application or application type based on an image of the display of the electronic device. If the AR device is capable of inferring a specific application on the electronic device (“Yes” at 1106), then, at 1108, control circuitry 904 infers a suitable application using embedding or machine learning. If not (“No” at 1106), then, at 1110, control circuitry 904 queries the electronic device for a suitable application using, for example, an API call.

At 1114, control circuitry 904 determines whether location parameters for application the input to the electronic device may be deduced from the gesture. For example, the gesture motion information may indicate a specific location within an application at which the insert the content item. The application may have different input fields, such as the recipient filed and the body field in an email drafting application. Alternatively, the type of gesture may be associated with a specific type of input. Location parameters for the specific type of input in the application may be deduced from the layout of the application.

If location parameters can be deduced (“Yes” at 1114), then, at 1116, control circuitry 904 sends an encapsulated input message to the electronic device with the location parameters. At 1118, the electronic device decapsulates the input with the location parameters. The content item may then be pasted into the appropriate input field.

If location parameters cannot be deduced (“No” at 1114), then, at 1120, control circuitry 904 sends an encapsulated input message to the electronic device without location parameters. At 1122, the electronic device decapsulates the input and detects a location to apply the input based on context. For example, the electronic device may determine that the content is an email address and paste it into the recipient field of an email drafting application.

If the AR device does not have the capability to detect applications on the identified electronic device (“No” at 1104), then, at 1124, control circuitry 904 sends captured, processed input to the electronic device. At 1126, the electronic device determines the application and location within the application at which to apply the input based on context. For example, the electronic device may determine that the content item is an email address. Based on this determination, the electronic device may identify an email drafting application and paste the content item into a recipient field.

After the electronic device determines the application and location within the application at which to apply the input (1126), or after the electronic device decapsulates the input received from the AR device (1118 or 1122), at 1128, the electronic device uses input emulation to display the input on the electronic device in the identified application and/or location within the application. For example, if a text input is received, the electronic device may place focus on a text input field of the application and process the text input through a keyboard input emulation module.

In some embodiments, the AR device may be granted access to directly input content into the electronic device. In such embodiment, if the location parameters for applying the input can be deduced from the gesture (“Yes” at 1114), then, at 1130, the AR device sends a message to the electronic device with location parameters. The message may include a request for write access to an input field associated with the location parameters. At 1132, the electronic device identifies an input field associated with the location parameters. For example, the location parameters may indicate a specific portion of the display of the electronic device. The electronic device may then be able to identify an input field located in the indicated portion of the display.

If the location parameters for applying the input cannot be deduced from the gesture (“No” at 1114), then, at 1134, the AR device sends a message to the electronic device without location parameters. The message may include a request for write access to an input field to be identified by the electronic device. At 1136, the electronic device detects an input field in which the apply the input based on context. For example, the electronic device may determine that the content is an email address and paste it into the recipient field of an email drafting application.

At 1138, the electronic device grants the AR device write access to the input field. For example, the electronic device may open a remote input port or may loosen permissions normally applied to the input field to allow the AR device to act as a remote controller, keyboard, or other input device. At 1140, the AR device uses input emulation to display the input on the electronic device in the input field. For example, the AR device may have a remote keyboard emulation module through which text may be entered by the AR device into the input field on the electronic device.

The actions and descriptions of FIGS. 11A, 11B, and 11C may be used in any other embodiment of this disclosure. In addition, the actions and descriptions described in relation to FIGS. 11A, 11B, and 11C may be done in suitable alternative orders or in parallel to further the purposes of this disclosure.

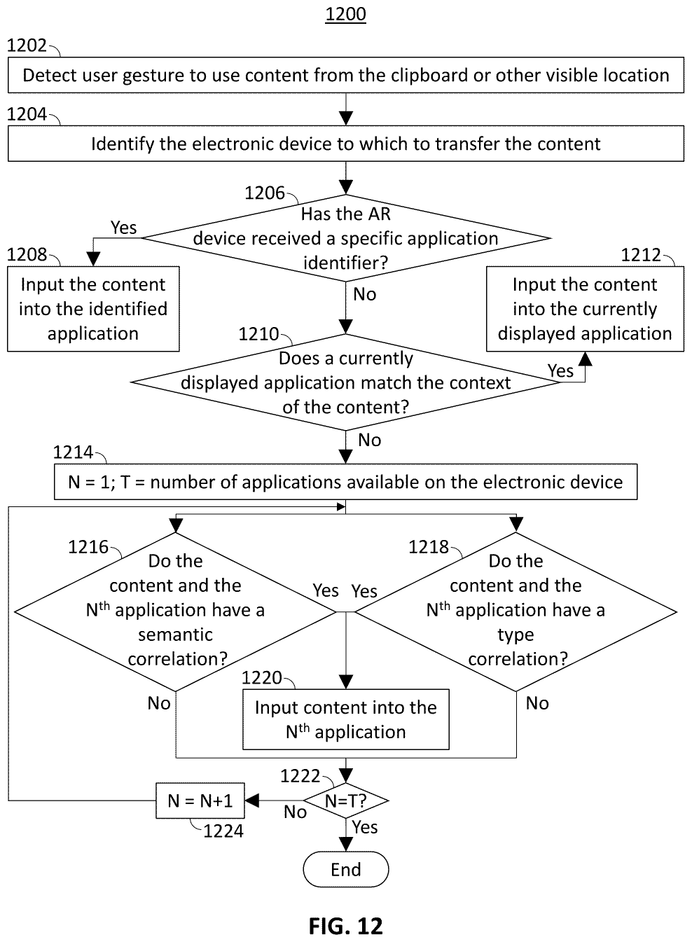

FIG. 12 is a flowchart representing an illustrative process 1200 for identifying an application on an electronic device into which to input transferred content, in accordance with some embodiments of the disclosure. Process 1200 may be implemented on control circuitry 904. In addition, one or more actions of process 1200 may be incorporated into or combined with one or more actions of any other process or embodiments described herein.

At 1202, control circuitry 904 detects a user gesture to use content from the clipboard or other visible location. For example, control circuitry 940 may recognize a hand gesture of the user as indicating a selection of both a content item from the clipboard area and another device within the field of view of the AR device. An example of such a gesture may be a grabbing or pinching gesture in the clipboard display area followed by a movement, throwing, or pointing gesture toward another device, or simply outward from the AR device.

At 1204, control circuitry 904 identifies an electronic device to which to transfer the content. This may be accomplished using methods described above in connection with FIGS. 4 and 10. At 1206, control circuitry 904 determines whether a specific application identifier has been received. For example, the user may indicate a specific application to which content should be transferred through a gesture, voice command, or other selection. If a specific application identifier has been received (“Yes” at 1206), then, at 1208, control circuitry 904 inputs the content into the identified application. For example, control circuitry 940 may use input emulation as described above in connection with FIGS. 11A-11C.

If a specific application identifier has not been received (“No” at 1206), then, at 1210, control circuitry 904 determines whether a currently displayed application on the electronic device matches the context of the content. For example, the content may be determined to be a URL. Control circuitry 904 may determine, using methods described above, that the application currently displayed on the display of the electronic device is a web browser. Control circuitry 904 may then further determine that a URL matches the context of a web browser. If the currently displayed application matches the context of the content (“Yes” at 1210), then, at 1212, control circuitry 904 inputs the content into the currently displayed application. This may be accomplished using methods described above in connection with FIGS. 11A-11C.

If the currently displayed application does not match the context of the content (“No” at 1212), then, at 1214, control circuitry 904 initializes a counter variable N, setting its initial value to one, and a variable T representing the number of applications available on the electronic device. At 1216, control circuitry 904 determines whether the content and the N^{th} application have a semantic correlation. For example, the content may be an image of a lampshade. Within the previous 15 minutes (or any other threshold period of time), the user may have discussed lampshade with a contact via email, SMS, chat, or phone. Control circuitry 904 may query metadata associated with the N^{th} application to determine if the subject of a lampshade was present within the previous 15 minutes to determine if there is a semantic correlation.

At 1218, control circuitry 904 determines whether the content and the N^{th} application have a type correlation. For example, control circuitry 904 may determine that the content is an email address. Control circuitry 904 may then determine whether the N^{th} application is an email client. If so (“Yes” at 1218), or if the content and the N^{th} application have a semantic correlation (“Yes”at 1216), then, at 1220, control circuitry 904 inputs the content into the N^{th} application.

For example, control circuitry 904 may use input emulation as described above in connection with FIGS. 11A-11C.

If the content and the N^{th} application have neither a semantic correlation (“No” at 1216) nor a type correlation (“No” at 1218), then, at 1222, control circuitry 904 determines whether N is equal to T, meaning that all available applications on the electronic device have been considered. If N is not equal to T (“No” at 1222), then, at 1224, control circuitry increments the value of N by one, and processing returns to steps 1216 and 1218. If N is equal to T (“Yes” at 1222), then there are no additional applications to consider, and the process ends. Control circuitry 904 may, in some embodiments, alert the user that no matching application was found on the electronic device. Control circuitry 904 may also present the user with an option to manually select an available application.

The processes described above are intended to be illustrative and not limiting. One skilled in the art would appreciate that the steps of the processes described herein may be omitted, modified, combined, and/or rearranged, and any additional steps may be performed without departing from the scope of this disclosure. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should be noted that the systems and/or methods described above may be applied to, or used in accordance with, other systems and/or methods.

1. A method for utilizing an AR device as a copy-paste utility, the method comprising:
capturing, using the AR device, a representation of a content item from a real-world environment;
identifying an electronic device within a field of view of the AR device;
detecting a user gesture to transfer the representation of the content item to the electronic device; and
in response to detecting the user gesture:
determining a context of the electronic device into which the representation of the content item should be transferred; and
transmitting, to the electronic device, a command to cause transfer of the representation of the content item to the electronic device in the determined context.

2. The method of claim 1, wherein capturing, using the AR device, a representation of a content item from a real-world environment comprises:
detecting a second user gesture;
identifying an area of the field of view of the AR device corresponding to the second user gesture; and
extracting, from the area of the field of view, a representation of the content item.

3. The method of claim 1, further comprising displaying, on a display of the AR device, the representation of the content item.

4. The method of claim 1, wherein identifying an electronic device within a field of view of the AR device comprises:
recognizing the electronic device within the field of view of the AR device;
transmitting a beacon to devices in proximity to the AR device;
receiving, from the electronic device, a response to the beacon;
transmitting an indicator to the electronic device; and
receiving, from the electronic device, a response to the indicator.

5. The method of claim 4, wherein the indicator is one of a visual indicator or an audio indicator.

6. The method of claim 1, wherein determining a context of the electronic device into which the representation of the content item should be transferred comprises identifying an application displayed on a display of the electronic device.

7. The method of claim 6, wherein identifying an application displayed on a display of the electronic device comprises:
transmitting a query to the electronic device for an application that currently has focus; and
receiving, in response to the query, an identifier of the application that currently has focus.

8. The method of claim 6, wherein identifying an application displayed on a display of the electronic device comprises:
capturing an image of the display of the electronic device;
processing the image using a machine learning model trained on a set of images of applications; and
determining, based on the processing, an application type of the application displayed on the display of the electronic device.

9. The method of claim 6, wherein multiple applications are concurrently displayed on a display of the electronic device, the method further comprising:
extracting motion information from the user gesture;
determining, based on the motion information, a path along which the gesture points;
determining a portion of the display of the electronic device that intersects the path; and
identifying an application displayed in the portion of the display.

10. The method of claim 6, further comprising:
identifying an application type of the application displayed on a display of the electronic device; and
in response to determining, based on the application type, that the application displayed on a display of the electronic device is a telecommunications application, identifying at least one contact with whom the telecommunications application is communicating;
wherein transmitting, to the electronic device, a command to cause transfer of the representation of the content item to the electronic device in the determined context further comprises transmitting, to the electronic device, a command to cause the representation of the content item to be transmitted to the at least one contact.

11. The method of claim 1, wherein determining a context of the electronic device into which the representation of the content item should be transferred comprises:
determining a subject matter of the content item;
comparing the subject matter with a plurality of applications available on the electronic device; and
selecting, based on the comparing, an application.

12. The method of claim 1, wherein determining a context of the electronic device into which the representation of the content item should be transferred comprises:
determining a subject matter of the content item;
comparing the subject matter with conversation metadata for conversations between the electronic device and one or more contacts; and
selecting, based on the comparing, a contact of the one or more contacts with which to share the representation of the content item.

13. A system for utilizing an AR device as a copy-paste utility, the method comprising:
a visual sensor; and
control circuitry configured to:
capture, using the visual sensor, a representation of a content item from a real-world environment;
identify an electronic device within a field of view of the AR device;
detect a user gesture to transfer the representation of the content item to the electronic device; and
in response to detecting the user gesture:
determine a context of the electronic device into which the representation of the content item should be transferred; and
transmit, to the electronic device, a command to cause transfer of the representation of the content item to the electronic device in the determined context.

14. The system of claim 13, wherein the control circuitry configured to capture, using the visual sensor, a representation of a content item from a real-world environment is further configured to:
detect a second user gesture;
identify an area of the field of view of the AR device corresponding to the second user gesture; and
extract, from the area of the field of view, a representation of the content item.

15. The system of claim 13, wherein the control circuitry is further configured to display, on a display of the AR device, the representation of the content item.

16. The system of claim 13, wherein the control circuitry configured to identify an electronic device within a field of view of the AR device is further configured to:
recognize the electronic device within the field of view of the AR device;
transmit a beacon to devices in proximity to the AR device;
receive, from the electronic device, a response to the beacon;
transmit an indicator to the electronic device; and
receive, from the electronic device, a response to the indicator.

17. The system of claim 16, wherein the indicator is one of a visual indicator or an audio indicator.

18. The system of claim 13, wherein the control circuitry configured to determine a context of the electronic device into which the representation of the content item should be transferred is further configured to identify an application displayed on a display of the electronic device.

19. The system of claim 18, wherein the control circuitry configured to identify an application displayed on a display of the electronic device is further configured to:
transmit a query to the electronic device for an application that currently has focus; and
receive, in response to the query, an identifier of the application that currently has focus.

20. The system of claim 18, wherein the control circuitry configured to identify an application displayed on a display of the electronic device is further configured to:
capture an image of the display of the electronic device;
process the image using a machine learning model trained on a set of images of applications; and
determine, based on the processing, an application type of the application displayed on the display of the electronic device.

21. The system of claim 18, wherein multiple applications are concurrently displayed on a display of the electronic device, and wherein the control circuitry is further configured to:
extract motion information from the user gesture;
determine, based on the motion information, a path along which the gesture points;
determine a portion of the display of the electronic device that intersects the path; and
identify an application displayed in the portion of the display.

22. The system of claim 18, wherein the control circuitry is further configured to:
identify an application type of the application displayed on a display of the electronic device; and
in response to determining, based on the application type, that the application displayed on a display of the electronic device is a telecommunications application, identify at least one contact with whom the telecommunications application is communicating;
wherein the control circuitry configured to transmit, to the electronic device, a command to cause transfer of the representation of the content item to the electronic device in the determined context is further configured to transmit, to the electronic device, a command to cause the representation of the content item to be transmitted to the at least one contact.

23. The system of claim 13, wherein the control circuitry configured to determine a context of the electronic device into which the representation of the content item should be transferred is further configured to:
determine a subject matter of the content item;
compare the subject matter with a plurality of applications available on the electronic device; and
select, based on the comparing, an application.

24. The system of claim 13, wherein the control circuitry configured to determine a context of the electronic device into which the representation of the content item should be transferred is further configured to:
determine a subject matter of the content item;
compare the subject matter with conversation metadata for conversations between the electronic device and one or more contacts; and
select, based on the comparing, a contact of the one or more contacts with which to share the representation of the content item.

25. A system for utilizing an AR device as a copy-paste utility, the system comprising:
means for capturing, using the AR device, a representation of a content item from a real-world environment;
means for identifying an electronic device within a field of view of the AR device;
means for detecting a user gesture to transfer the representation of the content item to the electronic device; and
means for, in response to detecting the user gesture:
determining a context of the electronic device into which the representation of the content item should be transferred; and
transmitting, to the electronic device, a command to cause transfer of the representation of the content item to the electronic device in the determined context.

26-60. (canceled)
